(19) United States
(12) Patent Application Publication
(10) Pub. No.: US 2018/0068223 A1
(43) Pub. Date: Mar. 8, 2018

(54) COGNITIVE KNOWLEDGEBASE FOR PROVIDING IMAGE-MATCHING SEARCHES

(71) Applicant: Bimal Mankara Balan, Piscataway, NJ (US)

(72) Inventor: Bimal Mankara Balan, Piscataway, NJ (US)

(21) Appl. No.: 15/259,223

(22) Filed: Sep. 8, 2016

(51) Int. Cl. G06N 5/02; G06F 17/30

(52) U.S. Cl. CPC G06N 5/022; G06F 17/30268

(57) ABSTRACT

Systems and methods that enable an end user to resolve an image related query by performing an image based search. It provides an easier method to resolve the image based queries by carrying out searches in a knowledgebase using an ITSM tool. It further provides a method in which the knowledgebase relates and compares an image/screen-shot of a query uploaded on the knowledgebase, with the existing knowledgebase-record(s) and conducts searches to find the matching knowledgebase records/details in terms of relevance. It further illustrates ways to build a knowledgebase by creating and adding to the knowledgebase-records. The end users thus get an accurate solution set with regard to the query faced.

### FIELD OF THE INVENTION

The present invention relates generally to a method and system that enables a query resolution by image search. More specifically, it relates to an image-based information retrieval tool to enable an easy and effective method to store and search the related information with the help of image-search feature, in a knowledgebase of image-based information. Still more specifically, the present invention relates to making searches in a knowledgebase easier and resolving query quicker, by providing images/screen-shots of the web page or application.

### BACKGROUND OF THE INVENTION

IT Service Management is a strategic approach to designing, delivering, managing and improving the way information technology (IT) is used within an organization. The goal of IT service management is to ensure that the right processes, people and technology are in place so that the organization can meet its business goals. The term IT service management is often associated with finest practices known as internal IT infrastructure library (ITIL) that provides best practices for aligning IT with business needs. Such an internal IT infrastructure library provides support to IT services in aligning the needs of the business and support its core processes. It provides guidance to organizations and individuals on how to use IT as a tool to facilitate business change, transformation and growth. The ITIL framework supports to improve efficiency and achieve predictable service levels. The ITIL framework also enables an IT service organization to be a business service partner, rather than just back-end support.

Mostly, the IT service industries have a centralized database or a predefined repository of information, which is used by the end users to solve their queries of day-to-day work activities. The predefined repositories/centralized databases in general are associated with the applications or processes that the organization is using for carrying out their day-to-day activities. The end users access these predefined repositories/centralized databases by using various available search tools.

As a general practice, end users try to resolve the queries they come across while using these applications or processes by using keywords or error message texts. These keywords or error messages that appear while using the application(s) are searched inside these predefined repositories/centralized database to find resolution to their queries. For this, the end users have to copy the error message correctly and do texts searches. These methods for resolving the queries have various drawbacks. For example, the end user should be able to type the text messages or copy the message correctly from the application and perform a search in the predefined repositories/centralized database. Certain applications' texts cannot be copied to computer memory, as they do not provide options to select the text or perform the copy operations such as windows desktop applications. In such a case, end users have to be very cautious while entering the data manually at the predefined repositories/centralized database search box. In cases where the error message is a lengthy, or a complicated text, it is difficult to type the text without typos. In addition, the users should be aware of the actual keyword or text that is essentially used for the search.

Further, existing search techniques/methods are restrictive in terms of data used to conduct the searches, i.e., searches are conducted using text-based or keyword-based search only. In this, a text-search on a database field identifies the records and related data from the predefined repositories/centralized database and display the results to the end users. Thus, under the existing method, end users have to carry out following steps to identify the record: (a) Identify the appropriate keyword, which may yield a good search result. Alternatively, users may copy the text that appears on the computer while using the application; (b) Type the text in the search box and perform a search; (c) The predefined repositories/centralized database should then display the result based on the keywords provided; and (d) The end user then has to screen through the links and identify the appropriate solution for their query.

The above method is an error prone method where user is relying on knowing the text/error message/keywords, to incorporate to the search field. Therefore, there is a need to find enhanced methods to resolve image related queries. Accordingly, the present invention overcomes these problems by accomplishing the method that resolves an image related query by performing image based searches.

### SUMMARY OF THE INVENTION

It is therefore, an object of the present invention to provide a method, which enables an End User to resolve a query by performing image based searches.

It is a further object of the present invention to provide an image-based information retrieval tool (ITSM tool) to enable an easy and effective method to store and search the related information with the help of an image-search feature, in a knowledgebase of image-based information.

It is a further object of the present invention to provide a method to update a knowledgebase with subsequent creation of knowledgebase records related to a particular subject.

The composition of the present invention, the methods and the embodiments therein are described herein below which are illustrative only and should not be construed to limit the scope of the present invention in any manner. Unless stated to the contrary, any use of the words such as “including,” “containing,” “comprising,” “having” and the like, means “including without limitation” and should not be construed to limit any general statement that it follows to the specific or similar items or matters immediately following it. Embodiments of the invention are not mutually exclusive, but may be implemented in various combinations.

According to the present invention herein below:

“Knowledgebase” as used herein is a predefined repository/centralized database of information related to a particular subject. The knowledgebase is a relational database built on a particular subject by creating, collating and categorizing knowledgebase records related to and based on various problems relevant to the particular subject. These repositories are then open for use by the service organizations and the End user(s). End users can access this knowledgebase using various tools for instance, an ITSM tool.

“ITSM tool” (Information Technology Service Management tool) as used herein is interchangeable with HTML based user interface tool, used by the organization to track end users' query from creation to closure. Further, it supports the end user as an image-based information retrieval tool, wherein end users access the tool to report a query, to search in knowledgebase as well as to provide updates about the queries reported by them. The end users generally search queries they come across while operating any organizational application using an ITSM tool on the knowledgebase.

“System” as used herein is an entire setup collectively referring to a HTML based user interface tool, which is built up on a relational database and middleware developed on PYTHON programming language.

“End user” as used herein is a normal user in the system who can login, search in predefined repository/centralized databases, report queries or creates support requests in the ITSM tool.

“Knowledgebase administrator” as used herein is a back-end user who has read and writes access to the entire knowledgebase. The knowledgebase administrator will decide whether the knowledgebase record will/will not be added to the knowledgebase. The knowledgebase administrator should have the rights to add, delete and/or modify a knowledgebase record.

“Support Engineer” as used herein is a support engineer who plays a key role in constructing the knowledgebase. The support engineer should have the right to access the support requests created by the end user and work on the query. The support engineer should coordinate with the end user(s) to understand the query and help end user(s) to find a solution for the query. While updating the resolution in the ITSM tool, the support engineer will have an option to create a knowledgebase record related to the query and send it for the knowledgebase administrator's approval.

“Support requests” as used herein is a request created by the end user for the support engineer. In this, the end user reports the problem faced while using the application to the support engineer. The support engineer should work on the problem addressed by the end user in the support request and help the end user to find a solution for the problem.

In accordance with a first illustrative embodiment of the present invention, a method to construct a knowledgebase related to a particular subject wherein, knowledgebase records are created related to a particular subject. The creation of knowledgebase records are carried out in two ways:

Manual Process: In accordance with an aspect of this first illustrative embodiment of the present invention, the knowledgebase administrator or support engineer should access the knowledgebase application from the ITSM Tool and create a new record. While creating the record, the details of symptom, cause, relevance and resolution method of the query are to be provided. Additionally, the knowledgebase administrator or support engineer should also provide an option to attach images to the record created.

As a part of Support Request Resolution: In accordance with another aspect of this first illustrative embodiment of the present invention, a record is created as a part of the support request resolution. According to this process, while resolving a query reported by the end user in the support request, the support engineer may create a knowledgebase record related to the request that is resolved by him/her. The support engineer should collect the details of the query and update symptom, cause, relevance, and, resolution details of the knowledgebase record. Further, the support engineer should create screenshots of the query and relate and collate them in order of relevance to the knowledgebase record that is created.

On one occasion, the knowledgebase record created in either of the ways mentioned in the above embodiments, the knowledgebase record is further subjected to approval. The knowledgebase administrator carries out the approval of the knowledgebase record. The knowledgebase administrator should manually review the record created and decide whether the record is to be saved in the knowledgebase or not. If the record created is repetitive of the existing record or found to be irrelevant by the knowledgebase administrator, the record is deleted. Alternatively, the knowledgebase administrator approves the record created and saves the record, so that the record is available for the end user and support engineers for subsequent searches. Thus, according to the present invention, the knowledgebase records created for various such subjects relevant to the IT service management are made available to the end users and support engineers for enabling image based searches.

These and other objects and advantages of the present invention will become apparent from a reading of the following specification. There has thus been outlined, rather broadly, the more important features of the present invention in order that the detailed description thereof that follows may be better understood, and in order that the present contribution to the art may be better appreciated.

### BRIEF DESCRIPTION OF THE DRAWINGS

FIG. 1 is a flowchart of one of the embodiments of the present invention showing the method to perform an image related search in the knowledgebase using an image based query.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein

In accordance to the present embodiment of the present invention, there is provided a method to construct a knowledgebase repository related to a particular subject wherein, knowledgebase records are created related to a particular subject. These records are further subjected to approval process prior to the records made available to the end users or support engineers. The creation of knowledgebase records in the present invention is carried out in two ways:

A. Manual Process: In accordance with an aspect of this first illustrative embodiment of the present invention, knowledgebase administrator or support engineer should access the knowledgebase application from the ITSM tool and create a new record. While creating the record, the details of symptom, cause and resolution method of the query are to be provided. Additionally, the knowledgebase administrator or support engineer should also provide an option to attach images to the record created.

B. As a part of the Support Request Resolution: In accordance with another aspect of this first illustrative embodiment of the present invention, a record is created as a part of the support request resolution. According to this process, while resolving a query reported by the end user, the support engineer will request a knowledgebase record creation related to the request that is resolved by him/her. The support engineer should collect the details of the query and update symptom, cause and resolution details of the knowledgebase record. Further, the support engineer should create screenshots of the query and relate them to the knowledgebase record that is been created.

On one occasion, the knowledgebase record is created when the screenshots are attached to the knowledgebase records in the following steps: (a) Access the knowledgebase application; (b) Collect the screenshots of the query and upload to the system using the ‘upload’ image option provided in the ITSM Tool; (c) Select knowledgebase records in the system and mark them as related to the screenshot just uploaded; (d) Repeat the step (iii) if other knowledgebase records are relevant to the screenshot uploaded; and (e) Save the changes to the system.

Further, these knowledgebase records so created are subjected to approval in the system. The knowledgebase administrator carries out the approval of the knowledgebase record. The knowledgebase administrator should manually run through the record created and decide whether the record is to be saved in the knowledgebase or not. If the record created is a repetitive of an existing record, or found to be irrelevant by the knowledgebase administrator, the record may be deleted from the knowledgebase. Alternatively, if the knowledgebase administrator approves the record created, the record may be saved to the knowledgebase, and may be available to the end user and support engineers for subsequent searches.

Thus, according to the present invention, the knowledgebase records may be built for various such subjects relevant to the IT service management. These records may then be available to the end users and support engineers for subsequent image based searches.

In accordance with one of the embodiment of the present invention, the creation of the knowledgebase record may be simplified in the following steps as: (a) Login the system; (b) Access ITSM tool; (c) Access “new record”; (d) Set the access levels of the records; (e) Provide symptom details of the query; (f) Provide cause details of the query; (g) Provide resolution details of the query; and (h) Save the record in the system.

According to another embodiment of the present invention, the knowledgebase may be built on a particular subject by creating knowledgebase records relevant to the particular subject. These repositories may then be open for use by the organization and the end user. The end user(s) may then carry out image related searches using the ITSM tool by using the image search feature of the tool, to find the related information from knowledgebase as a solution to the query.

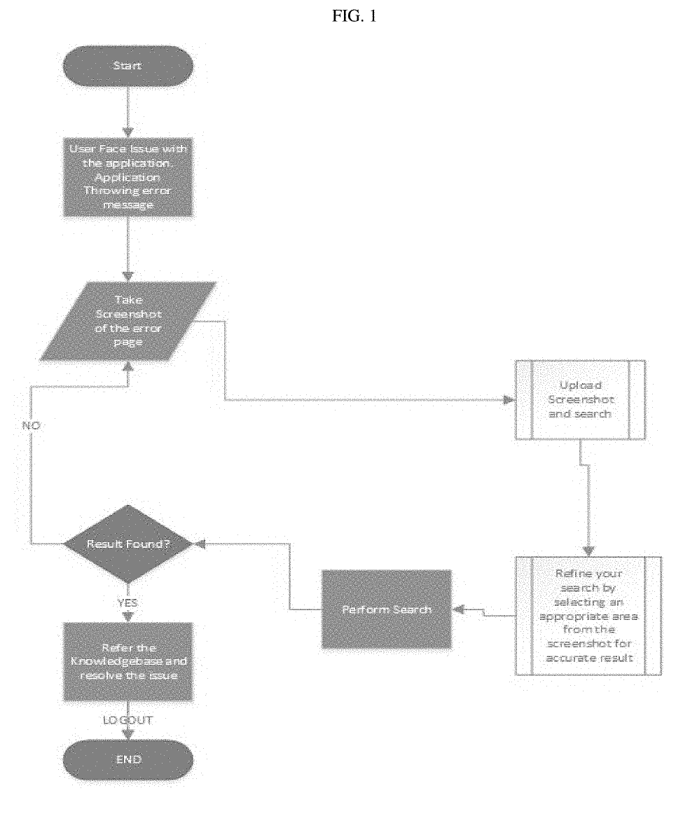

Thus according to one of the embodiment of the present invention, FIG. 1 is a workflow of the steps that are performed while carrying out the image search on the knowledgebase using the ITSM tool. This is better understood from an illustration as described in detail herein. Supposedly, a user, while using an application in an organization during their daily operation, faces a particular error message when he/she accesses that application. The user wishes to identify what is the query and wishes to identify how to fix the query. Thus, to identify the query, the end user should login to the knowledgebase using the knowledgebase application such as ITSM tool and use the image search feature to find the related information in the following steps: (1) Take a screenshot of the application error page and save to the desktop/workstation; (2) Login to the knowledgebase search page and select advanced search option; (3) Upload the image created at step 1 using the interface provided in the ITSM tool; (4) The tool will provide an option to refine the search by allowing the user to select most relevant area from the image uploaded at step 3; (5) The knowledgebase does an image search at the images database and find out the most matching images from the knowledgebase; and (6) The user refers to the knowledgebase and finds out the resolution for the query he/she faced at the application

Thus, the present invention provides an easy and quicker manner to resolve the day-to-day work issues faced by the end users in various organizations while using the organization's applications. In addition, it provides an easy manner to conduct an image based search in the knowledgebase to find a resolution to image related searches. Further, it provides an easy manner to create knowledgebase records, which construct the knowledgebase database.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method for enabling an end user to resolve an image related query by performing image based searches within a system, comprising the steps of:
taking a screenshot of any application error page and saving it on any workstation as an image;
logging into the system;
uploading and searching the image using an interface tool of the system on a knowledgebase, wherein the end user can refine the search using defined options available in the knowledgebase of the system;
performing a search to find out the most relevant record from the knowledgebase of the system;
finding out the resolution for the query by the end user from the most relevant records; and
uploading the image for a back-end user to resolve the queries for which no matching records are obtained in the knowledgebase of the system.

2. The method as claimed in claim 1, wherein the interface tool is an ITSM tool used to track an end users' query from creation to closure and the knowledgebase is a database of knowledgebase records.

3. The method as claimed in claim 1, wherein the back-end user includes:
a support engineer who make new records by resolving the query uploaded by the end user and uploading the resolution of the query, details of symptoms, cause and resolution methods of the query, and has read and write access to the entire database; and
a knowledgebase administrator who verifies and approves the resolution of the query provided by the support engineer before making the records available to the end user.

4. The method as claimed in claim 1, wherein the end user is a user who can login, search in a predefined knowledgebase, report queries or create support requests in the ITSM tool.

5. The method as claimed in claim 1, wherein the records are a knowledgebase record of the knowledgebase, which are created in at least one of two ways and is further subjected to knowledgebase administrator's approval before making it available to any user

6. The method as claimed in claim 5, wherein the two ways of creating the records include either the knowledgebase administrator or the support engineer directly creating a new record comprising the details of symptom, cause and resolution methods of the query by accessing the subject application, or, by resolving the query uploaded by the end user and uploading the resolution, details of symptom, cause and resolution methods of the query to the query as a new knowledgebase record to the knowledgebase of the system using an image upload option of the ITSM tool.
